(19) United States
(12) Patent Application Publication
(10) Pub. No.: US 2018/0376177 A1
(43) Pub. Date: Dec. 27, 2018

(54) SYSTEM AND METHODS FOR INDIVIDUALIZED DIGITAL VIDEO PROGRAM INSERTION

(71) Applicant: Vidillion, Inc., Las Vagas, NV (US)

(72) Inventors: Dennis M. Nugent, Las Vegas, NV (US); Steve Popper, Incline Village, NV (US); Daniel De Vera, Montevideo (UY)

(21) Appl. No.: 14/522,568

(22) Filed: Oct. 23, 2014

Related U.S. Application Data
(60) Provisional application No. 61/894,859, filed on Oct. 23, 2013.

(51) Int. Cl. H04N 21/234; H04L 29/06; H04L 29/08; H04N 21/2381

(52) U.S. Cl. CPC H04N 21/23424; H04N 21/2381; H04L 67/02; H04L 65/601

(57) ABSTRACT

A method of delivering video content to an IP-connected device comprises: sending a request for the video content, providing a source video stream and splicing information to an ingest server, determining video stream properties, determining splicing properties packaging the source video stream and properties to an edge server, and integrating a commercial video clip into the source video stream.

### CROSS REFERENCE TO RELATED APPLICATION

The present application is related to Provisional Patent Application entitled “System and Methods for Individualized Digital Video Program Insertion,” filed 23 Oct. 2013 and assigned filing No. 61/894,859, incorporated herein by reference in its entirety.

### FIELD OF THE INVENTION

This invention relates to a system and method of seamlessly integrating video content provided from a second source into video content provided by a first source.

### BACKGROUND OF THE INVENTION

The accessibility and consumption of video content over the Internet has grown exponentially over the past years. As a result, more and more video content consumers have switched to watching or accessing video content on, and through, Internet-connected devices capable of reaching a variety of video content resources spread throughout the world. In connection with this shift of viewing habits to accessing Internet-based video content, video content providers have sought to monetize and support such video delivery by incorporating video-based advertisements into and around the video content requested by users.

Advertisers seek to reach these viewers by inserting or embedding video advertisements within the video stream. For example, advertisers may desire to include a short video advertisement around certain highly-requested videos. Television clip insertion is the process of inserting (splicing) an advertising message into a media stream such as a television program. For traditional television broadcasting systems, TV ads are typically inserted on a national or geographic basis that is determined by the distribution network. For television systems that can use destination addressing, ads can be directed to specific users based on a device, content, viewer's profile, or other available information.

Internet Connected Television video clip insertion is the process of inserting (splicing) a video message into a video stream such as a television program or on-line movie. For Internet Connected Television video broadcasting systems, video clips or ads are typically inserted on content distributor specifications, a language, genre, or geographic basis that is determined by the video service provider.

What is needed is a method for splicing individually targeted content into a live or on-demand video stream using an HTTP video streaming protocol, without discontinuity and without explicit DPI support from a HTTP video player.

### BRIEF DESCRIPTION OF THE DRAWINGS

FIG. 1 is a block diagram of a digital program insertion system comprising a user computer device functioning to receive video programming from a HLS-DPI edge server that is in communication with a Live Stream Digital Program Insertion ingest server and a digital access generator server, in accordance with the present invention;

FIG. 2 is a diagrammatic illustration showing an HTTP Live Stream from the Live Stream Digital Program Insertion ingest server to the HLS-DPI edge server of FIG. 1;

FIG. 3 is a flow diagram illustrating operation of the Live Stream Digital Program Insertion ingest server of FIG. 1;

FIG. 4 illustrates segments of HLS video versus time, and potential time periods in which new HLS video segments may be generated;

FIG. 5 illustrates segments of HLS video versus time, and potential time periods in which no new HLS video segments are generated;

FIG. 6 illustrates segments of HLS video versus time, with no chopped segment for an out-point or an in-point;

FIG. 7 is a functional block diagram illustrating various components of a system configured to an HTTP Live Stream (HLS) from the HTTP Live Stream (HLS) Digital Program Insertion (DPI) ingest server to the HLS-DPI edge server, for HLS video delivery over the Internet to an individual user video player, in accordance with the present invention;

FIG. 8 is a functional block diagram illustrating various components of a system configured to provide request, response, and delivery of a video segment over the Internet, in accordance with the present invention;

FIG. 9 is a functional block diagram of the system of FIG. 8, at the stage of a process where an ad insertion opportunity has been identified;

FIG. 10 is a functional block diagram of the system of FIG. 8, at the stage of the process where the edge server is delivering a spliced ad to the video player of the user's device;

FIG. 11 is a is a functional block diagram of the system of FIG. 8, with a return to a prepared source stream;

FIG. 12 is a flow diagram illustrating operation of the HLS-DPI edge server in determining a current state of operation for the digital program insertion system of FIG. 1;

FIG. 13 is a flow diagram illustrating operation of the HLS-DPI edge server when the current state of operation for the digital program insertion system is a source stream play out state;

FIG. 14 is a flow diagram illustrating operation of the HLS-DPI edge server when the current state of operation for the digital program insertion system is an alternative source preparation state; and,

FIG. 15 is a flow diagram illustrating operation of the HLS-DPI edge server when the current state of operation for the digital program insertion system is an alternative source play out state.

### DETAILED DESCRIPTION OF THE INVENTION

The present disclosure describes digital program insertion (DPI) systems and methods for splicing individually targeted content, such as video ads, into a live or on demand video program stream using an HTTP video streaming protocol, such as HTTP Live Streaming “HLS” or MPEG-DASH, to Internet Protocol connected devices without discontinuity and without explicit DPI support from the HTTP video player.

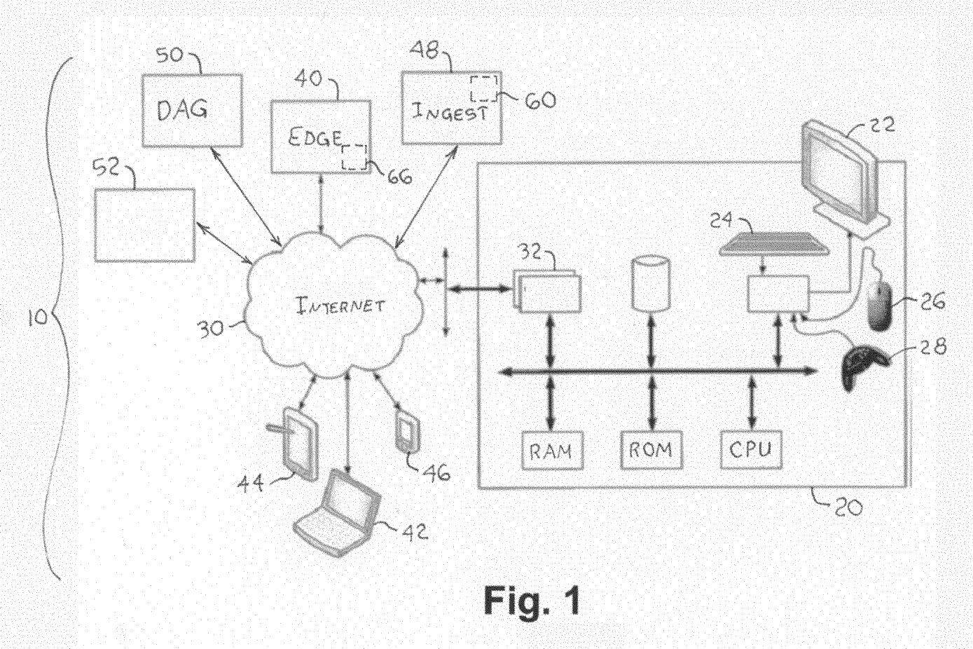

FIG. 1 shows a functional block diagram of a digital program insertion system 10, suitable for individualized insertion of programming material into streaming video made accessible to users, in accordance with the present invention. In the configuration shown, a user may have a computer device 20 for downloading or streaming a selected video program onto a display device, such as a monitor 22. The user may require a keyboard 24, a mouse 26 and/or a game controller 28 to access and control the selected video program.

The computer device 20 may comprise one or more communication ports 32 for communication with other network systems and computer networks via the Internet/Cloud 30 (hereinafter Internet). For example, the communication port 32 may be in communication with a television set top box (not shown), where the television set top box is typically a device that connects to the Internet 30 and an input panel on a television set. In an exemplary embodiment, the computer device 20 may communicate with an edge server 40, or other content provider 52, for accessing the selected video program. In addition, the computer device 20 may communicate with other communications devices accessing the Internet 30, such as a personal computer 42, a tablet computer 44, personal digital assistants, a mobile communications device 46, and other systems.

When the user requests content from the content provider, via a communications device of his choice, a number of variables may be provided to the content provider in connection with the user's request. For example, the user's request may include one or more of the following information related to the communication device being used: (i) user agent, (ii) browser type, (iii) Internet Protocol (IP) address, (iv) a globally-unique identifier (GUID) that may be represented, for example, as a 32-character hexadecimal string, (v) a Unique Device (or viewer) ID, (vi) device operating system (e.g., Windows, Linux), (vii) Apple's identifier for advertising (IDFA), and (viii) acceptable languages.

The video content server, such as the edge server 40, may automatically timestamp the user's request. After the video content server decides that it can and should provide the requested content to the user, the video content server will supply the video content, and may optionally update one or more database tables or logging servers documenting the transaction event.

A user's request for video content, in connection with an embodiment, may be routed to a secondary application server, commonly referred to as a Digital Access Generator (DAG) server 50. The DAG server 50 functions to generate: (i) Advanced Stream Redirector (ASX), or (ii) Extensible Markup Language (XML) files, or (iii) playlists, in response to a user request. The ASX, XML files, or playlist may contain a listing of one or more locations, such as identified by a Uniform Resource Locator (URL), containing the requested video content, or other video content, that should be accessible to the user's communication device in response to the user's initial request. The DAG server 50 may function in coordination with an HLS-DPI Ingest Server 48 that is in charge of receiving splicing information, when provided. Preferably, the HLS-DPI Ingest Server 48 includes digital video program stream software 60 to the splicing information, as described in greater detail below.

In an exemplary embodiment, the DAG server 50 may be accessed using a single global subdomain name, for example, “dag.total-stream.net.” The sub-domain name may resolve to a single IP address that is announced globally by the content provider via border gateway protocol (BGP) from multiple locations. This routing approach serves to permit users to be routed to the “nearest” point on the net announcing the given destination IP when attempting to connect to the single global sub-domain name of the DAG Server 50.

As can be appreciated by one skilled in the relevant art, the disclosed Digital Program Insertion (DPI) system and methods provide the ability to insert, or splice, content into an Hyper Text Transfer Protocol (HTTP) video stream without discontinuity support from the HTTP video player. This process may be used with video ads, but it is also applicable to the splicing of any video content.

Although the disclosed implementation is based on HTTP Live Streaming (HLS), the disclosed DPI system and methods can be used to add DPI capabilities to other HTTP streaming protocols such as, for example, Moving Picture Expert Group—Dynamic Adaptive Streaming over HTTP (MPEG-DASH) without requiring DPI support from the HTTP video player.

A proposed HLS specification includes a capability called “Discontinuities” that describes a method of performing DPI with support from the HLS video player. However, discontinuity support may be absent, incomplete, or defective in the HLS video players of many devices which are otherwise capable of playing HLS video streams. This malfunction in player operation results in a negative impact on viewer's quality of service.

The disclosed methods describe how a current HLS—DPI system may function and, in particular, without discontinuity support from the HLS video player. The present invention discloses: (i) a method providing per-stream execution flow, that is, actions that are executed for every configured stream, and (ii) a method providing per-stream execution flow method, that is, actions executed based on individual user request.

In the per-stream execution flow method, each video stream configured in the system requires two input parameters: (1) a source HTTP Live Stream stream's Uniform Resource Locator, and (2) a splicing method for obtaining the insertion point, that is, splicing information.

Multiple mechanisms are available for determining when to splice the video source stream. For example, the Society of Cable Telecommunications Engineers (SCTE) 30, 35, or 104 messages, analog Dual-tone multi-frequency (DTMF) cue-tones, and Timecode information. Some of these methods, such as SCTE 35 messages and analog cue-tones use signals, may be embedded into the video source stream. Other methods, such as Timecode, use signals that will be delivered to the HLS-DPI ingest server 48 through an external, or “out-of-band,” mechanism.

The disclosed digital program insertion system 10 supports at least three methods of video stream insertion. In a first method, denoted as a random method, the digital program insertion system 10 splices the input video program stream randomly. In a second method, denoted as a Timecode-based method, the digital program insertion system 10 splices the input video program stream based on Timecode information. In a third method, denoted as a cue-tone based method, the digital program insertion system 10 uses messages and dual-tone multi-frequency (DTMF) cue-tones standardized by the International Telecommunications Union—Telecommunications Standardization Sector (ITU-T) Recommendation Q.23 to splice the input video program stream. In an exemplary embodiment, the edge server 40 includes individualized digital insertion software 66 or application to modify input stream segments, described in greater detail below.

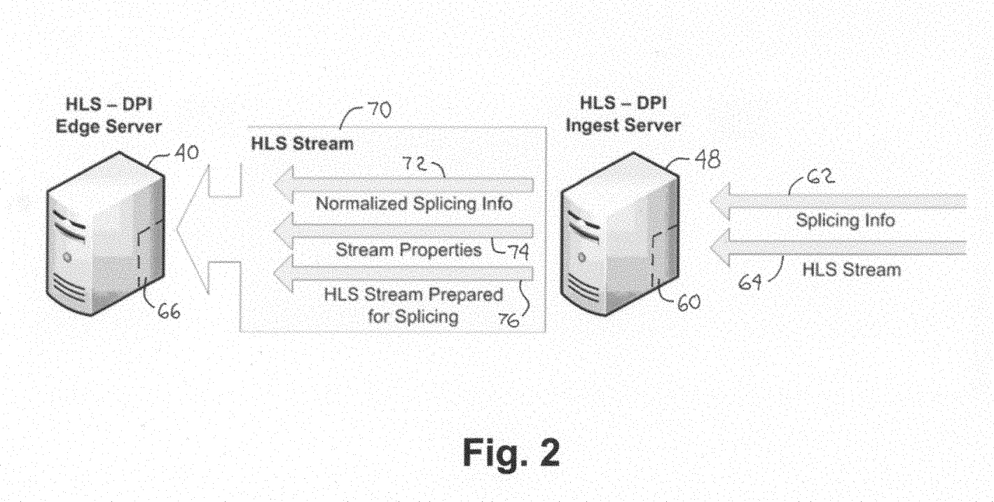

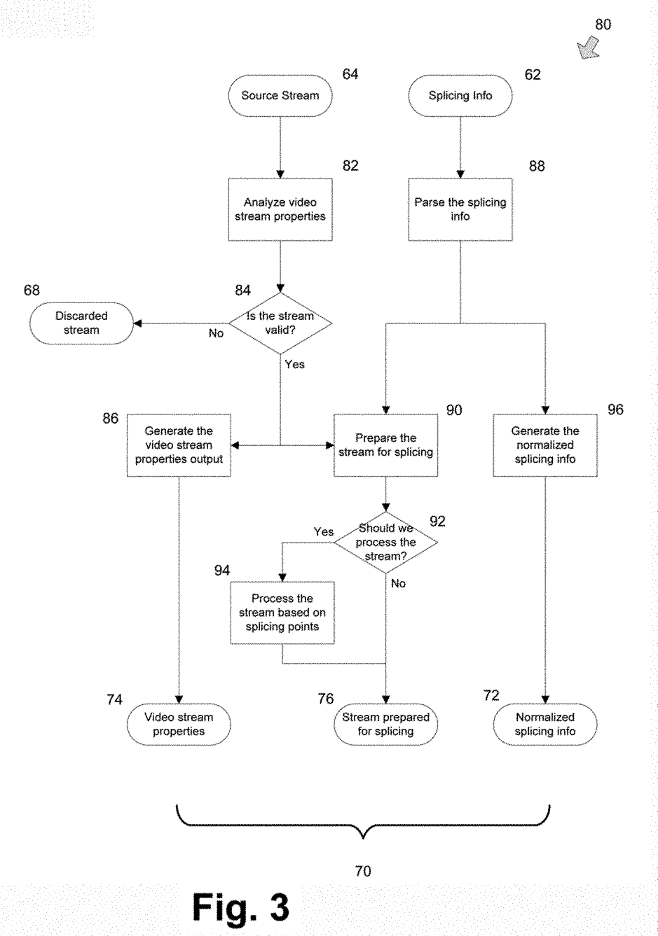

As shown in FIG. 2, the HLS-DPI Ingest Server 48 is the service in charge of receiving and reading splicing information 62 from custom tags embedded in an Source HLS stream 64, in accordance with a digital video program stream process 80, shown in FIG. 3. In an exemplary aspect of the present invention, the digital video program stream software 60, or application, resident in the HLS-DPI Ingest Server 48, inputs the source HLS stream 64 and reads the splicing information 62 to produce one or more of the following outputs: (i) normalized splicing information 72, (ii) video stream properties 74, and (iii) HLS stream prepared for splicing 76. The three outputs 72, 74, and 76 may be packaged into a single HLS output stream 70, wherein the HLS output stream 70 comprises the sole input to the HLS DPI Edge Server 40. Each of the outputs 72, 74, and 76 is described in greater detail below.

In an exemplary embodiment, the source HLS stream 64 may be modified by at least one of transcoding and transrating the bitrate in the source HLS stream 64 prior to providing the source HLS stream 64 to the HLS-DPI Ingest Server 48. As understood by one skilled in the relevant art, “transcoding” is the direct analog-to-analog or digital-to-digital conversion of one encoding to another, such as for movie data files (e.g., PAL, SECAM, NTSC) or audio files (e.g., MP3, WAV).

A first output of the HLS-DPI Ingest server 48, denoted as the video stream properties 74 of the source HLS stream 64, may be analyzed and determined within the HLS-DPI ingest server 48, at step 82, and transmitted to one or more HLS-DPI edge servers 40 in the form of HLS comment tags. If the source HLS stream 64 is determined to be invalid, at decision block 84, the source HLS stream 64 may be output as a discarded stream 68. Otherwise, video stream properties 74 may be determined by methods known in the relevant art such as, for example, using the open source tool “ffprobe” from the FFmpeg project to analyze the properties of the incoming source HLS stream 64. These stream properties 74 may include but are not limited to:
MPEG-TS Program Map Table (PMT) Program ID (PID),
video PID,
video codec,
video profile,
video level,
video frame rate,
video width,
video height,
video sample aspect ratio,
video display aspect ratio,
maximum number of concurrent B-frames in video,
audio PID,
audio codec,
audio rate, and
audio channels.

The HLS video stream 74 properties, generated at step 86, may be output in the form of a HLS comment tag with the following structure:

#SPLICE-ENCODING:M-PMT-PID=[??],
V-PID=[??],
VCODEC=“[??]”,
VPROFILE=“[??]”,
V-LEVEL=[??],
V-FPS=[??],
V-WIDTH=[??],
V-HEIGHT=[??],
VSAR=“[??]”,
V-DAR=“[??]”,
V-BFRAMES=[??],
A-PID=[??],
A-CODEC=“[??]”, ARATE=[??],
A-CHANNELS=[??]

For example, the HLS comment tag may incorporate data, as shown in the sample data tag given below:

#SPLICE-ENCODING:M-PMT-PID=4096,
V-PID=256,
V-CODEC=“h264”,
VPROFILE=“high”,
V-LEVEL=30,
V-FPS=25.00,
V-WIDTH=854,
V-HEIGHT=480,
VSAR=“1:1”,
V-DAR=“427:240”,
V-BFRAMES=2,
A-PID=257,
A-CODEC=“aac”,
ARATE=44100,
A-CHANNELS=2

These properties may be used by the HLS-DPI edge server 40 to prepare a secondary video stream, such as one or more video ads, for splicing, in order to make the properties of the video insertion match the video stream properties 74 of the source HLS stream 64.

As shown in digital video program stream process 80, the HLS-DPI ingest server 48 may further determine a second output, denoted as the HLS stream prepared for splicing 76, from the source HLS stream 64, or ‘network’ stream ingested into the HLS-DPI ingest server 48. After the splicing information 62 has been parsed, at step 88, the content preparation process takes the source HLS stream 64 and the splicing information 62 as input, and prepares the stream for splicing, at step 90. In an exemplary embodiment, a decision may be made, at decision block 92, to output the prepared stream directly to the HLS-DPI edge server 40.

Otherwise, if the prepared stream is not sent directly to the HLS-DPI edge server 40, the digital video program stream process 80 may function to process the prepared stream by generating new HLS segments for an out-point and/or an in-point, at step 94, and then send the prepared stream to the HLS-DPI edge server 40. An out-point is an opportunity to insert an ad. An in-point is a return to the source HLS stream 64 flow. The digital video program stream process 80 may also function to generate the normalized splicing information 72 at step 96, after the splicing information has been parsed, at step 88.

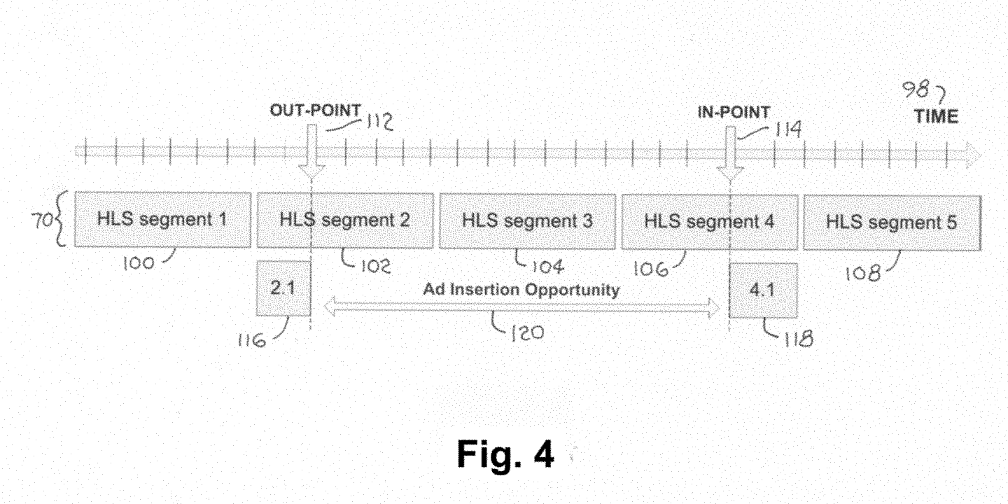

In the illustration provided in FIG. 4, a portion of the HLS output stream 70 is represented by five sequential HLS segments, here denoted as a first HLS segment 100, a second HLS segment 102, a third HLS segment 104, a fourth HLS segment 106, and a fifth HLS segment 108, with a time axis 98 extending to the right. The normalized splicing information 72 indicates that there is an ad insertion opportunity 120 that begins with an out-point 112 in the second HLS segment 102, and which ends at an in-point 114 in the fourth HLS segment 106.

Accordingly, the digital video program stream process 80 may “chop” the second HLS segment 102, creating a first sub-segment 116 (herein labeled as sub-segment 2.1, comprising a portion of chopped second HLS segment 102). The content preparation process may also chop the fourth HLS segment 106, creating a second sub-segment 118 (herein labeled as sub-segment 4.1, comprising a portion of chopped fourth HLS segment 106).

Preferably, the second HLS segment 102 and the fourth HLS segment 106 are not discarded. The content preparation process generates additional segments, which may be subsequently used by the HLS-DPI edge server 40 to splice the HLS output stream 70. It should be understood that there is not necessarily any relationship between the duration of a video advertisement and the duration of any of the HLS segments 100-108.

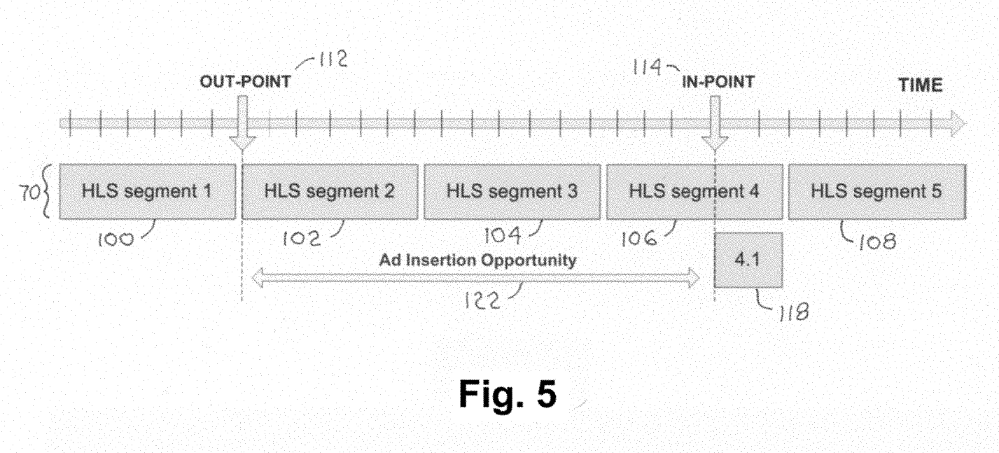

In the exemplary embodiment of the HLS output stream 70 shown in FIG. 5, no chopped segment is produced at the outpoint 112. It should be understood that not every splicing out-point or splicing in-point will result in a new HLS segment being generated. Rather, the production of chopped segments will depend on the position of the splicing-point inside the corresponding HLS segment. Accordingly, a splicing opportunity 122 results, extending from the beginning of the second HLS segment 102 to the beginning of the second sub-segment 118.

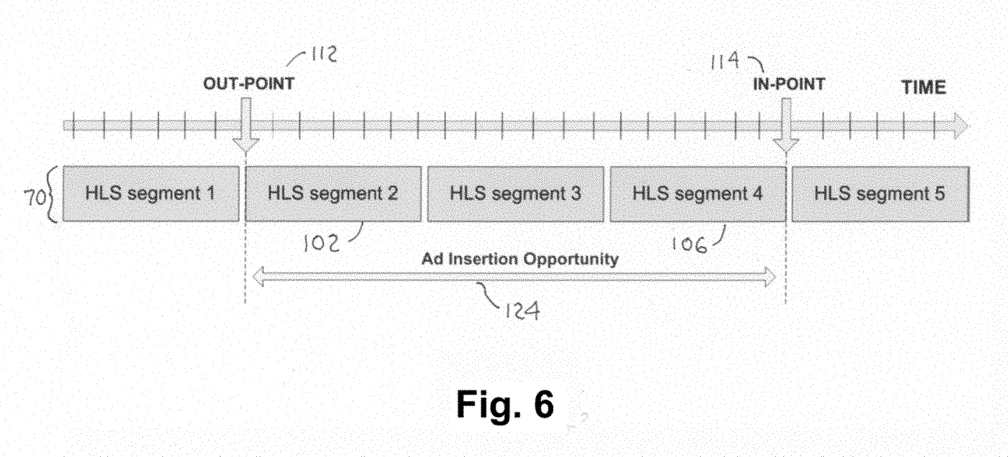

In the exemplary embodiment of the HLS output stream 70 shown in FIG. 6, no chopped segment is produced, either at the in-point 114 or at the out-point 112. Thus, there is no chopped segment, and an ad insertion opportunity 124 extends from the beginning of the second HLS segment 102 to the end of the fourth HLS segment 106.

As shown in FIG. 2, the HLS-DPI ingest server 48 determines the third output from the source HLS stream 64, denoted herein as the normalized splicing information 72. The normalized splicing information 72 is transmitted to the HLS-DPI edge server 40 to enable proper execution of the actual splices. The HLS-DPI ingest server 48 can receive the normalized splicing information 72 through various mechanisms. Splicing information can be normalized by mapping the splicing information to a common definition in order to reduce the workload for the HLS-DPI edge server 40. In an exemplary embodiment, the normalized splicing information 72 may comprise three messages, herein denoted as (1) a SPLICE-COMING message, (2) a SPLICE-OUT-POINT message, and (3) a SPLICE-IN-POINT message.

The SPLICE-COMING message may contain the following information:

SPLICE-EVENT-ID: a numeric ID of the splicing event.

BREAK-DURATION: the duration of the insertion opportunity 120 (in FIG. 4), 122 (in FIG. 5), and 124 (in FIG. 6).

The SPLICE-COMING message tells the HLS-DPI edge server 40 that in the near future there will be a splicing opportunity with a given duration (typically, in microseconds). The SPLICE-COMING message tells the HLS-DPI edge server 40 to prepare for an ad insertion by retrieving an ad and converting the ad to the correct format.

The SPLICE-COMING message may be transmitted to the HLS-DPI edge server 40 in the form of an HLS comment tag with the following structure:

#SPLICE-COMING:[SPLICE-EVENT-ID],[BREAK-DURATION]

For example:

#SPLICE-COMING:0,32745954

This means that the splicing event ‘0’ soon will arrive, and the splicing event ‘0’ will have duration of 32.74 seconds.

The SPLICE-OUT-POINT message may contain the following information:
SPLICE-EVENT-ID: a numeric ID of the splicing event.
NEXT-VIDEO-PTS: this is the presentation timestamp (PTS) in which the next video Packetized Elementary Stream (PES) should start. PES is a concept defined in the MPEG specification.
NEXT-TS-PCR: this is the program clock reference (PCR) value, which should be sent next.
CHOPPED-SEGMENT-URL: URL to download the chopped segment for this out-point. Note that the URL can be empty (if there is no chopped segment for the outpoint).
CHOPPED-SEGMENT-DURATION: duration of the chopped segment for this out-point.

The SPLICE-OUT-POINT message tells the HLS-DPI edge server 40 that a splicing event has arrived, identified by the SPLICE-EVENT-ID, and provides all the necessary information the HLS-DPI edge server 40 requires to replace a portion of the HLS output stream 70 with alternative content, such as an ad. The SPLICE-OUT-POINT message may be transmitted in the form of an HLS comment tag with the following format:

#SPLICE-OUT-POINT:[SPLICE-EVENT-ID],[NEXT-VIDEO-PTS],
[NEXT-TSPCR],
[CHOPPED-SEGMENT-URL],[CHOPPED-SEGMENT-DURATION]

For example:
#SPLICE-OUT-POINT:0,49244400,14771205314,137-out.ts,6.2
   where there is a chopped segment available (137-out.ts) with duration of 6.2 seconds, and:
#SPLICE-OUT-POINT:0,2826000,845640000,
   when there is no chopped segment.

The SPLICE-IN-POINT message contains the following information:
SPLICE-EVENT-ID: a numeric ID of the splicing event.
LAST-VIDEO-PTS: this is the presentation timestamp (PTS) that comprises the last video PES of the alternative content, such as an inserted ad.
LAST-TS-PCR: this is the value of the last program clock reference (PCR) sent in the alternative content, that is, in the inserted ad.
CHOPPED-SEGMENT-URL: URL to download the chopped segment for this in-point. Note that the URL can be empty if there is no chopped segment for the in-point.
CHOPPED-SEGMENT-DURATION: duration of the chopped segment for this in-point.

The SPLICE-IN-POINT tells the HLS-DPI edge server 40 to return to the HLS stream 70. The SPLICE-IN-POINT provides all the necessary information to accomplish this change. It should be understood that the HLS-DPI edge server 40 may act on this message only if the HLS output stream 70 had previously been spliced.

This message may be transmitted in the form of a HLS comment tag with the following format:

#SPLICE-IN-POINT:[SPLICE-EVENT-ID],[LAST-VIDEO-PTS],[LAST-
TSPCR],[CHOPPED-SEGMENT-URL],[CHOPPED-SEGMENT-
DURATION]

For example:
#SPLICE-IN-POINT:0,52102800,15628647273,140-in.ts,2.864

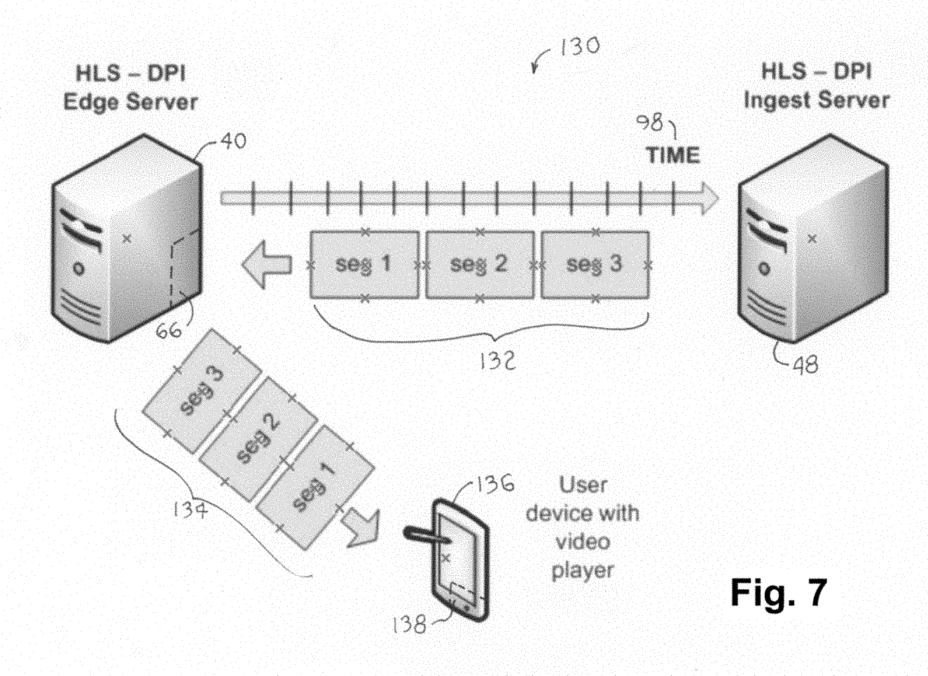

There is shown in FIG. 7 a functional block diagram illustrating various components of a digital program insertion system 130 configured to provide video delivery over the Internet, according to an exemplary embodiment. As shown in the diagram, a user or viewer may access a user video device 136 to send a request for a video stream interval 132 over the Internet to the HTTP Live Streaming—Digital Program Insertion (HLS-DPI) Edge Server 40. It should be understood that, for clarity of illustration, the video stream interval 132 is shown as comprising three video segments, but that the video stream interval 132 typically includes a larger number of video segments than is shown in the illustration.

The HLS-DPI Edge Server 40 may provide the video stream interval 132 as part of video viewer content 134 sent to the user video device 136. It can be appreciated that the video viewer content 134 may be substantially the same as the video stream interval 132, or the video viewer content 134 may have been modified from the video stream interval 132 by the individualized digital insertion software 66, as explained in greater detail below. The video stream interval 132 may comprise a portion of one or more of live streaming, movies on demand, or other requested video content, such as video clips, for example.

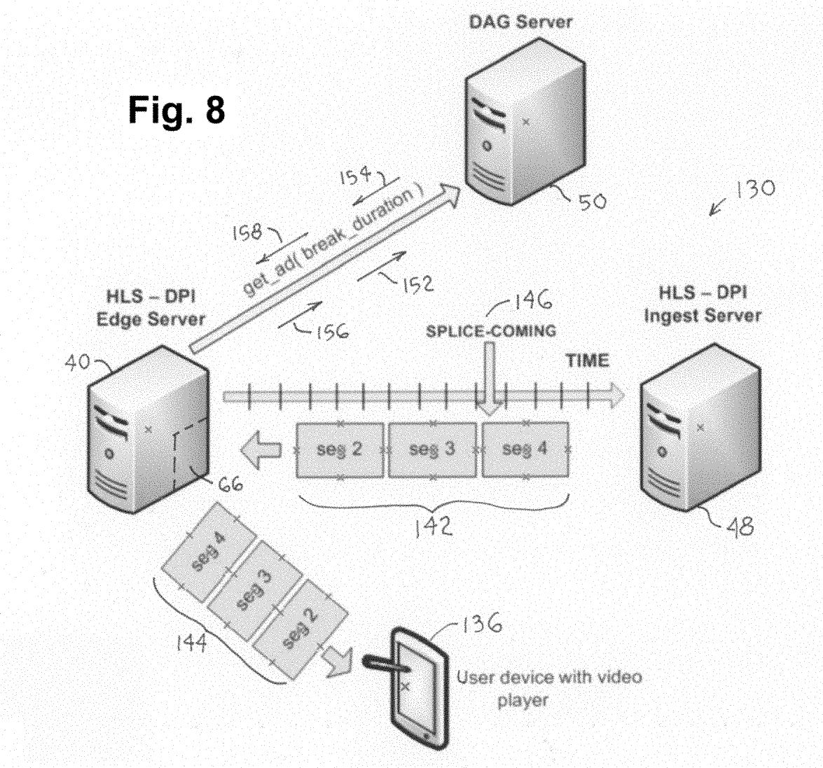

Operation of the digital program insertion system 130 to execute a Source Stream Play Out process is shown in FIG. 7. Other processes that may be executed by the digital program insertion system 130 can be explained with additional reference to FIGS. 8-11, below, in which the: (i) Ad Preparation State, (ii) Switching to Ad Play Out State, (iii) Ad Playback State; and (iv) Returning to Source Stream Play Out State respectively are illustrated in greater detail. The operations described below correspond to the steps that the individualized digital insertion software 66 in the HLS-DPI edge server 40 may execute during the distribution of content to a user or to the user video device 136.

During the process of Source Stream Play Out, that is, the play out of the source HLS stream 64 or the HLS stream 70 to the user HLS video device 136, the HLS-DPI edge server 40 may act as a proxy between the HLS-DPI ingest server 48 and the user HLS video device 136. The HLS-DPI edge server 40 obtains the HLS stream 70 prepared by the HLS-DPI ingest server 48 and sends HLS stream 70 to the user HLS video device 136. The HLS-DPI edge server 40 obtains the HLS output stream 70 as prepared by the HLS-DPI ingest server 48, and may receive ad content from the DAG Server 50. The HLS-DPI edge server 40 may then send the HLS output stream 70 with or without the ad content to the user HLS video device 136.

In the Ad Preparation State, shown in FIG. 8, the HLS-DPI Ingest Server 48 may be informed that a DPI splice opportunity 146 is coming. The individualized digital insertion software 66 in the HLS-DPI Edge Server 40 may forward that request information to an ad server or custom application server, such as the Digital Access Generator (DAG) Server 50. The DAG Server 50 may determine which ads or video clips are available to serve to the user viewer device 136 based on business logic and available spots. The DAG Server 50 may respond to an individual DPI Edge Server ad request 152 by returning ad content 154, such as an XML file, or other play list format with the appropriate ad or video content references.

Almost all IP connected devices with the video player software 138 include other information within the HTTP header, or the HTTP request. This may include the IP address, user agent, device type, browser, operating system, and player, for example. Almost all IP connected HTTP servers can include other information besides the requested information within the HTTP response. As an example, a request for one web page may include a response with both text and pictures. Similarly, a viewer request for video content may result in alternate video content, the requested video content, data, and/or text.

The HTTP response by the IP connected device HLS-DPI Edge Server 40 to the user video device 136 is HTTP Live Streaming (HLS) video content. The original HLS output stream 70 (here represented by a video stream interval 142) is transported to the HLS-DPI Edge Server 40 from the HLS-DPI Ingest Server 48. The source video or audio content is ingested into the HLS-DPI Ingest Server 48. The HLS user video player 138 establishes communication with the HLS-DPI edge server 40 in order to play a video or audio stream, such as user video content 144.

A single HLS-DPI ingest server 48 can feed multiple HLS-DPI edge servers 40 as necessary to handle the load from a large number of HLS user video players 136. The HLS-DPI edge server 40 is the server in charge of the content distribution to the user video players 138, and the individualized digital insertion software 66 in the HLS-DPI edge server 40 executes the content splicing. That is, the individualized digital insertion software 66 fills the insertion opportunities with alternative content, on a per user basis.

In the process of Ad Preparation, the digital video program insertion software 60 in the HLS-DPI ingest server 48 may insert the SPLICE-COMING message 124 into the video stream 120 transported to the HLS-DPI edge server 40. When a SPLICE-COMING message 146 appears in an HLS manifest published by the HLS-DPI ingest server 48, the HLS-DPI edge server 40 may make a request for ads for the corresponding splicing event. An ad request 152 may be made to an ad or video clip server, such as the DAG server 50. The ad request 152 may comprise a per-user process, and may be individualized based on unique viewer identification(s), as described in greater detail below. Such viewer identifications may include: (i) GUID, (ii) IP address, and/or (iii) Apples IdentifierForAdvertising (IDFA), for example.

During the process of moving video segments from the HLS-DPI ingest server 48 to the HLS-DPI edge server 40 with the SPLICE-COMING message 146 included in the video stream interval 142, the HLS-DPI edge server 40 may send a break notification 156 of a video or advertising break to the DAG server 50. The DAG server 50 may respond by sending a break response 158 that may include: (i) Advanced Stream Redirector (ASX), (ii) Extensible Markup Language (XML), (iii) other play list formats with URLs to the video ad location, or (iv) actual ads to be played.

In any such scenario, the HLS-DPI edge server 40 may check every ad in order to determine if the video source for that ad is already processed for the current stream. Specifically, the individualized digital insertion software 66 in the HLS-DPI edge server 40 will check to determine if there is a copy of the ad encoded with the same encoding properties as the source stream in storage (not shown). These encoding properties are read from the ingest SPLICE-ENCODING message provided by the HLS-DPI ingest server 48.

If any one of the returned ads was not previously processed, the HLS-DPI edge server 40 may launch a background process to prepare the ad identified as not having previously been processed. In accordance with the present invention, the identified ad will be prepared by encoding the identified ad with the same encoding properties as the encoding properties in the stream properties 74. It should be understood that, although the ad preparation process is a per-user process, the HLS-DPI edge server 40 will launch only one encoding process per ad video source. During this time period, defined as the time period lasting until there is an out-point published by the HLS-DPI ingest server 48, the HLS-DPI edge server 40 will continue streaming the viewer video content 144 to the user video device 136.

In another exemplary embodiment, the use of the DAG server 50 may not be required. The HLS-DPI edge server 40 may make the request for ads for a corresponding splicing event directly to any IP-connected ad server, ad network, or ad platform (not shown) as the source for useable video ads.

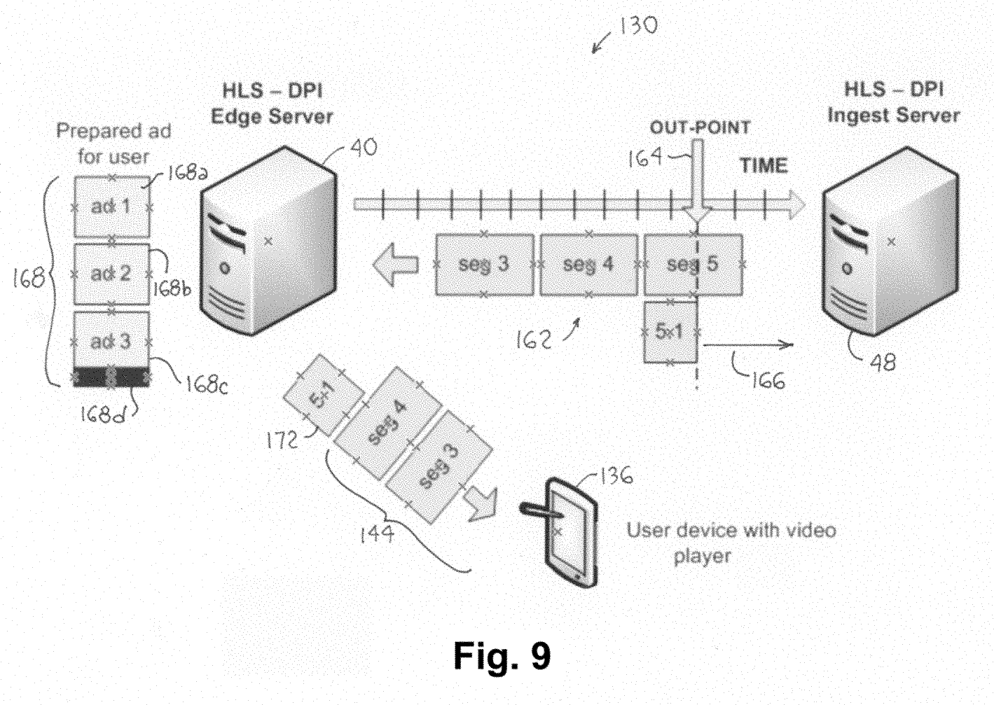

In the Switching to the Ad Play Out State, shown in FIG. 9, the HLS-DPI ingest server 48 publishes an out-point 164 in a video stream interval 162 and, in response, the HLS-DPI edge server 40 may determine if the HLS-DPI edge server 40 can fill in an ad break 166 corresponding to the out-point 164. The criteria for determining if the ad break 166 can be filled may include one or more variables, including, but not limited to: (i) ad break time duration, (ii) ad break time of day; (iii) content criteria such as genre, community, or language; (iv) viewer data such as location, how many ads the viewer has already seen within the last time period, and (v) type of user video device 136, and/or (vi) other user video device capabilities.

In the Switching to the Ad Play Out State, the individualized digital insertion software 66 in the HLS-DPI edge server 40 will check to determine if the DAG Server 50 has responded with any ad for the user video device 136. The HLS-DPI edge server 40 will determine if the ads provided by the DAG Server 50 have already been processed to have the same stream properties as the HLS output stream 70 inputted to the HLS-DPI edge server 40. Such an ad is denoted herein as a prepared ad set 168.

If the HLS-DPI edge server 40 cannot substitute a replacement ad in the current splice, then the HLS-DPI edge server 40 will continue playing out the viewer video content 144 to the user video device 136. But, if the HLS-DPI edge server 40 can substitute a replacement ad, the individualized digital insertion software 66 in the HLS-DPI edge server 40 will send a beginning chopped segment 172 to the user video device 136, and the HLS-DPI edge server 40 will switch to the Ad Playback State, described below. This is accomplished by changing the HLS Manifest file.

In an exemplary embodiment, the HLS manifests are generated dynamically per the user video device 136, including a manifest which contains the URL to download the chopped segment 172 from the HLS-DPI edge server 40, as described below:

#EXTM3U
#EXT-X-TARGETDURATION:10
#EXTINF:10 seg3.ts
#EXTINF:10 seg4.ts
#EXTINF:45.1.ts

The procedure for replacing the original HLS manifest is described below:

#EXTM3U
#EXT-X-TARGETDURATION:10
#EXTINF:10 seg3.ts
#EXTINF:10 seg4.ts
#EXTINF:10 seg5.ts

wherein the beginning chopped segment 172, that is, the segment identified as “5.1.ts” in the replacement HLS manifest has replaced the content segment “seg5.ts” in the original manifest. In this procedure, the viewer video content 144 is continuously sent to the user video device 136 from the HLS-DPI edge server 40. Thus, an HLS discontinuity flag is not needed or desired when the HLS Manifest file is changed.

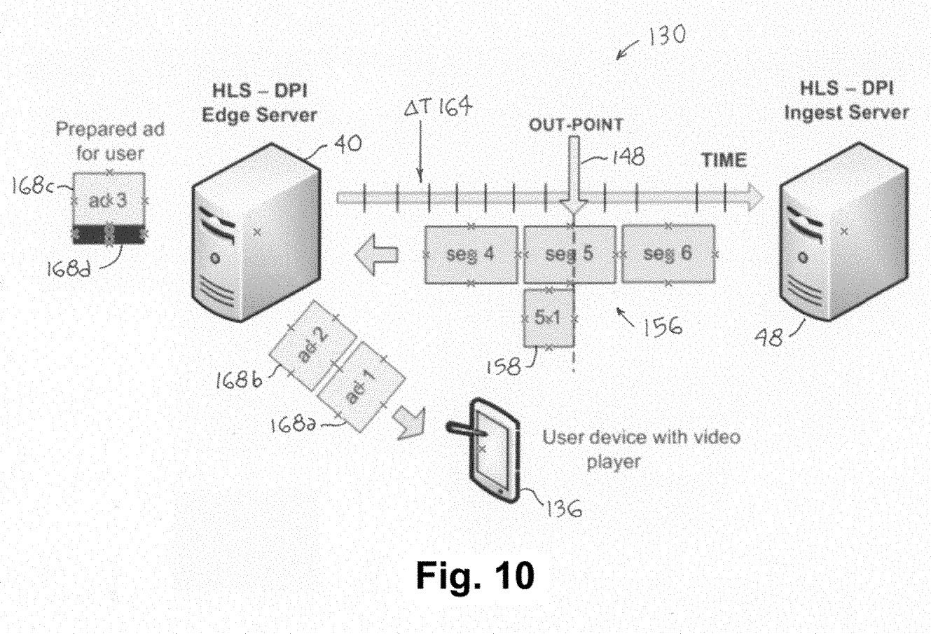

In the process of Ad Playback, shown in FIG. 10, and during the ad playback time period on the user video device 136, the time codes of each ad video segment 168a, 168b, 168c, are changed to match the time codes of the prepared HLS output stream 70 by the individualized digital insertion software 66. This is done using the NEXT-VIDEO-PTS and the NEXT-TS-PCR values that were included in the SPLICE-OUT-POINT message to the HLS-DPI Edge Server 40. The ad segments 168a and 168b are shown as having been published to the user's HLS user video device 136, but not the third ad segment 168c, so that the user video device 136 will start playing the prepared ad 168. In an exemplary embodiment, the individualized digital insertion software 66 may further function to change the time codes of each ad video segment.

In the embodiment shown, the third ad segment 168c has been padded with a specified time interval 168d of a black screen video, where the specified time interval 168d varies based on a combination of factors. At this time period in the delivery of video content to the user video device 136, the HLS-DPI edge server 40 has not received a signal that the HLS-DPI edge server 40 should switch back to the viewer video content 144. Thus, the third ad segment 168c is not delivered to the user video device 136.

The padding duration of time interval 168d is preferably large enough to assure that the total duration of the ad segments 168a, 168b, 168c made available for splicing is not less than the duration of the ad break specified in the break notification 156. Note that at this point in the process of Ad Playback, the HLS-DPI edge server 40 has not received the in-point message from the HLS-DPI Ingest server 48.

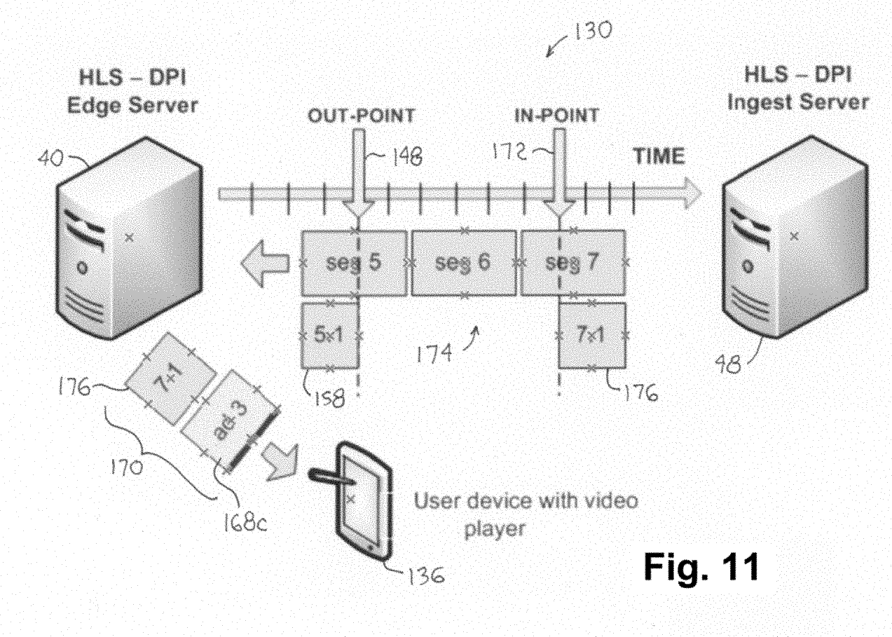

In the Returning to the Source Stream Flow Playback State, shown in FIG. 11, the HLS-DPI edge server 40 has received a message from the HLS-DPI ingest server 48 notifying of an in-point 172 in a video stream interval 174. At this interval in time, and knowing the in-point 172, the HLS-DPI edge server 50 can determine precisely at what subsequent time interval the HLS-DPI edge server 50 should switch the viewer video content 170 being sent to the user video device 136 back to the HLS output stream 70 from the HLS-DPI ingest server 48.

Thus, when the HLS-DPI edge server 40 finds an in-point, the HLS-DPI edge server 40 may switch back to viewer video content for delivery to the user video device 136. In order to accomplish this switching, using the example provided, the final segment of the prepared ad 168, the third ad segment 168c may be chopped at the correct time code. This action may be based on the LAST-VIDEO-PTS and the LAST-TSPCR values, included in the SPLICE-IN-POINT message from the HLS-DPI Ingest Server 48. The third ad segment 168c is then sent to the user video device 136, after which the HLS-DPI Edge Server 40 resumes sending the ending chopped segment 176, based on the in-point 172 if there is any, from the HLS-DPI Edge Server 40 to the user video device 136.

It can be appreciated by one skilled in the art that the ads delivered to the user video device 136 are unique for the particular user of the user video device 136. Accordingly, the particular user of the user video device 136 most probably received different video ads than were sent to users of other such user video devices, even though all users were being sent the same HLS output stream 70. Each individual user video device thus plays one or more ads, the ads customized for the respective user video device, and programming returns to the network stream. This process may be repeated for each ad break.

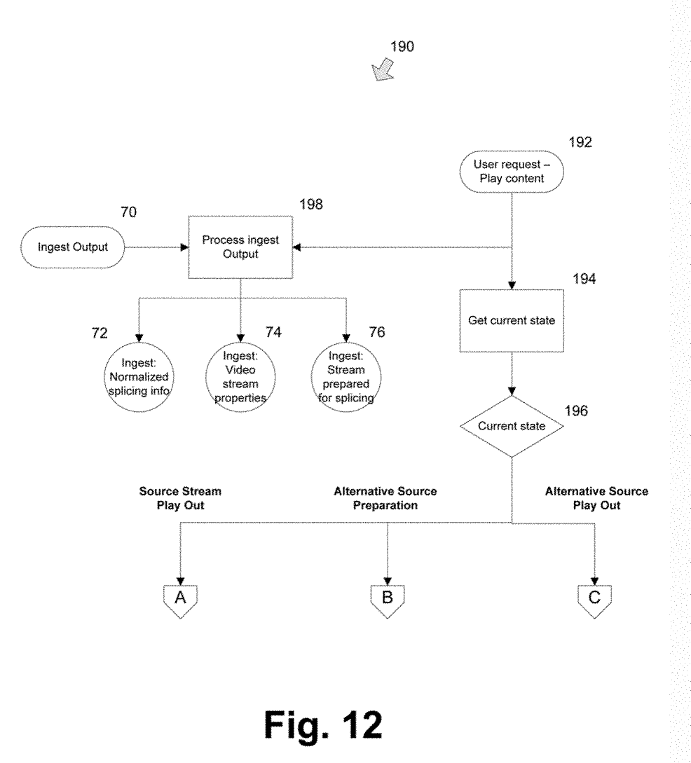

Operation of the digital program insertion system 10 may be explained with reference to flow diagrams presented in FIGS. 12 through 15. FIG. 12 is a flow diagram 190 illustrating a sequence of steps and operations initiated by the HLS-DPI edge server 40 after a user has sent a request for playable content, at step 192. The current state of the digital program insertion system 10 is requested, at step 194. The current state 196 is determined to be: (i) source stream play out, or (ii) alternative source preparation, or (iii) alternative source play out.

The ingest output 70 is obtained and processed, at step 198, to produce the normalized splicing information 72, the video stream properties 74, and the stream prepared for splicing 76. These parameters are utilized in subsequent operation of the digital program insertion system 10 as described above, and as further described below.

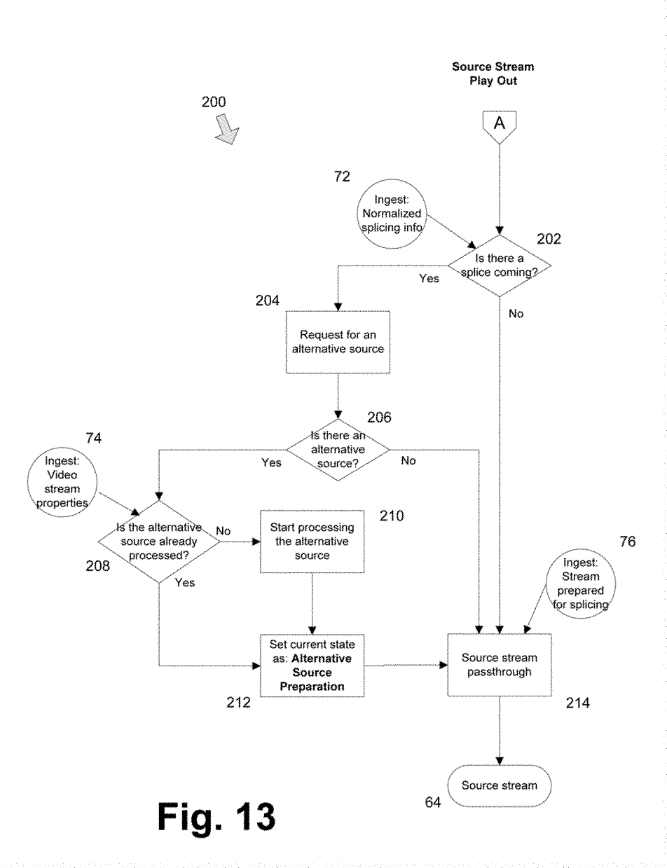

FIG. 13 is a flow diagram 200 illustrating a sequence of steps and operations performed when the digital program insertion system 10 is in the source stream play out state. The normalized splicing information 72 is accessed to determine whether or not a splice is in the incoming video stream, at decision block 202. If a splice is expected, a request for an alternative source may be made, at step 204.

If an alternative source is acquired, at decision block 206, a determination is made, at decision block 208 as to whether the alternative source is already processed. If not processed, the alternative source is processed, at step 210, and step 212 is performed. If the alternative source has been processed, at decision block 208, the current state is now set to alternative source preparation state, at step 212, and the source stream is passed through, at step 214.

If, at decision block 202, a determination is made that no splice is currently expected, based on the normalized splice information 72, the source HLS stream 64 is passed through, at step 214.

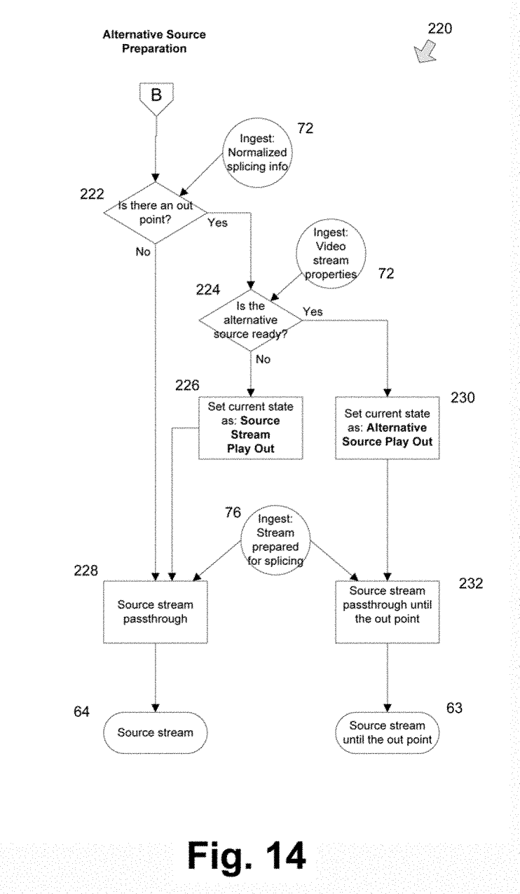

FIG. 14 is a flow diagram 220 illustrating a sequence of steps and operations performed when the digital program insertion system 10 is in the alternative source preparation state. The normalized splicing information 72 is referenced to determine whether or not there is an imminent out-point in the incoming video stream, at decision block 222. If an out-point is expected, a determination may be made, at step 224, as to whether an alternative source is ready. If not, the system is set to a source stream play out state, at step 226, and the source stream is passed through as the Source HLS stream 64, at step 228, with a reference to the stream prepared for splicing 76.

If the alternative source is ready, at decision block 224, the current state is set to the alternative source play out state, at step 230. The source stream is passed through until the out-point is reached, at step 232, with a reference to the stream prepared for splicing 76. An initial source stream 63 extending to the out-point is transmitted.

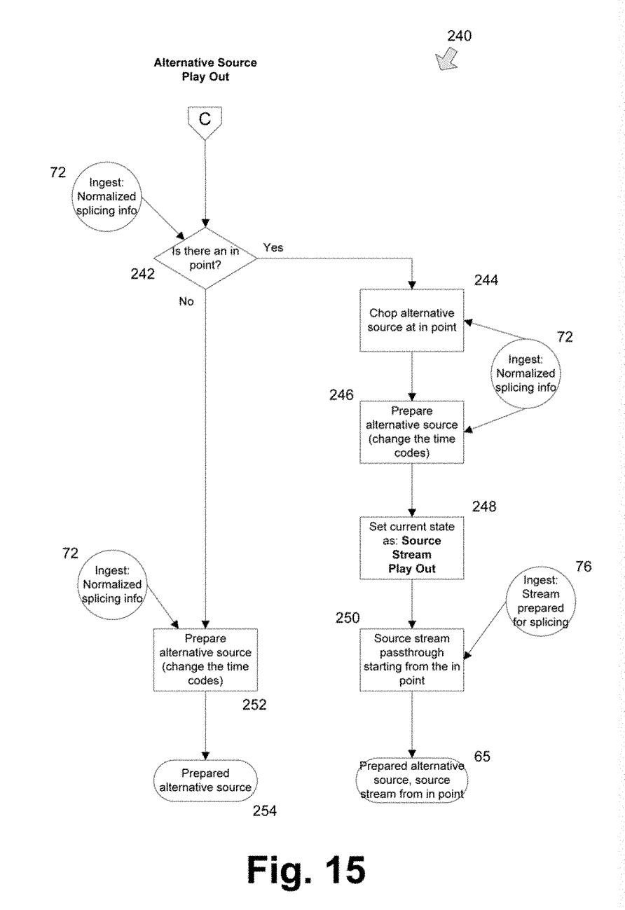

FIG. 15 is a flow diagram 240 illustrating a sequence of steps and operations performed when the digital program insertion system 10 is in the alternative source play out state. The normalized splicing information 72 is referenced to determine whether or not there is an imminent in-point in the incoming video stream, at decision block 242. If an in-point is expected, the alternative source is chopped at the expected in-point, at step 244.

Referencing the normalized splicing information 72, the alternative source is prepared, including changing the time codes of the alternative source to conform to the time codes of the source HLS stream 64. The current state is set to the source stream play out state, at step 248. Referencing the stream prepared for splicing 76, the source HLS stream 64 is passed through beginning with the in-point, at step 250, to transmit a partial prepared alternative source, comprising the portion of the source HLS stream 64 from the in-point.

The systems and methods described herein may be implemented in or upon computer systems, such as may include: (i) various combinations of central processor or other processing devices, (ii) an internal communication bus, (iii) various types of memory or storage media, such as RAM, ROM, EEPROM, cache memory, and disk drives, for code and data storage, (iv) one or more network interface cards, or (v) ports for communication purposes.

The systems and methods described herein may be used for a variety of uses and applications in which verification of content delivery is desirable. For example, the systems and methods described herein may be used to provide verification to third party advertisers who wish to distribute video advertisements in connection with other video content over the Internet. In some embodiments, a DAG Server may automatically include an advertisement with a request for other video content, and may include Start Verification Clip and End Verification Clip in a play list transmitted to a user's device for purposes of verifying delivery of the advertisement.

The systems and methods described herein may include or be implemented in software code, which may run on such computer systems or other systems. For example, the software code may be executable by a computer system, for example, that functions as the storage server or proxy server, and/or that functions as a user's terminal device. During operation the code may be stored within the computer system. At other times, the code may be stored at other locations and/or transmitted for loading into the appropriate computer system. Execution of the code by a processor of the computer system may enable the computer system to implement the methods and systems described herein.

The systems and methods described herein may be implemented in or upon such computer hardware platforms in whole, in part, or in combination. For example, aspects of the systems and methods described herein involving transmission or other sharing of data between systems may be implemented on systems such as the servers of FIG. 1.

The systems and methods described herein, however, are not limited to use in such systems and may be implemented or used in connection with other systems, hardware or architectures. The methods described herein may be implemented in computer software that may be stored in the computer systems and servers described herein.

A computer system or server, according to various embodiments, may include a data communication interface for packet data communication. The computer system or server may also include a central processing unit (CPU), in the form of one or more processors, for executing program instructions. The computer system or server may include an internal communication bus, program storage and data storage for various data files to be processed and/or communicated by the server, although the computer system or server may receive programming and data via network communications. The computer system or server may include various hardware elements, operating systems and programming languages. The server or computing functions may be implemented in various distributed fashions, such as on a number of similar or other platforms. The computer system may also include input and output (I/O) devices such as a mouse, game input device or controller, display, touch screen or other I/O device or devices in various combinations.

While various embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein may be employed in various embodiments.

Unless specifically stated otherwise, as apparent from the following discussions, it is appreciated that throughout the specification, discussions utilizing terms such as “processing,” “computing,” “calculating,” “determining,” or the like, may refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. It will also be appreciated by persons skilled in the art that the term “users” referred to herein can be individuals as well as corporations and other legal entities. Furthermore, the processes presented herein are not inherently related to any particular computer, processing device, article or other apparatus.

Examples of structures for a variety of these systems have been provided in the description above. In addition, embodiments of the invention have not been described with reference to any particular processor, programming language, machine code, etc. It can thus be appreciated that a variety of programming languages, machine codes, etc. may be used to implement the teachings of the invention as described above.

The methods described herein may be implemented in mobile devices such as mobile phones, mobile tablets and other mobile devices with various communication capabilities including wireless communications, which may include radio frequency transmission infrared transmission or other communication technology. Thus, the hardware described herein may include transmitters and receivers for radio and/or other communication technology and/or interfaces to couple to and communication with communication networks.

The methods described herein may be implemented in computer software that may be stored in the computer systems including a plurality of computer systems and servers. These may be coupled over computer networks including the Internet. Accordingly, an embodiment includes a network including the various system and devices coupled with the network.

Further, various methods and architectures as described herein, such as the various processes described herein or other processes or architectures, may be implemented in resources including computer software such as computer executable code embodied in a computer readable medium, or in electrical circuitry, or in combinations of computer software and electronic circuitry.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory, embedded microprocessors, firmware, software, etc.

Furthermore, aspects of the systems and methods may be embodied in microprocessors having software-based circuit emulation, discrete logic (sequential and combinatorial), custom devices, fuzzy (neural network) logic, quantum devices, and hybrids of any of the above device types. Of course, the underlying device technologies may be provided in a variety of component types, e.g., metal-oxide semiconductor field effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, email, etc.) over the Internet and/or other computer networks via one or more data transfer protocols (e.g., HTTP, FTP, SMTP, etc.).

When received within a computer system via one or more computer-readable media, such data and/or instruction-based expressions of components and/or processes under the systems and methods may be processed by a processing entity (e.g., one or more processors) within the computer system in conjunction with execution of one or more other computer programs.

Unless the context clearly requires otherwise, throughout the description and the claims, the words ‘comprise,’ ‘comprising,’ and the like are to be construed in an inclusive sense as opposed to an exclusive or exhaustive sense; that is to say, in a sense of ‘including, but not limited to.’ Words using the singular or plural number also include the plural or singular number respectively. Additionally, the words ‘herein,’ ‘hereunder,’ ‘above,’ ‘below,’ and words of similar import refer to this application as a whole and not to any particular portions of this application. When the word ‘or’ is used in reference to a list of two or more items, that word covers all of the following interpretations of the word: any one or more of the items in the list, all of the items in the list and any combination of the items in the list.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the claims, the terms used should not be construed to limit the systems and methods to the specific embodiments disclosed in the specification and the claims, but should be construed to include all processing systems that operate under the claims.

While certain aspects of the systems and methods are presented below in certain claim forms, the inventors contemplate the various aspects of the systems and methods in any number of claim forms. Accordingly, the inventors reserve the right to add additional claims after filing the application to pursue such additional claim forms for other aspects of the systems and methods.

The various features described above may be combined in various combinations. Without limitation, features described may be combined with various systems, methods and products described. Without limitation, multiple dependent claims may be made based on the description herein.

While embodiments of the invention have been shown and described herein, those skilled in the art will appreciate that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A method of delivering video content to an IP-connected device, said method comprising the steps of:
sending a request for the video content from the IP-connected device to a video source server;
providing to an ingest server (i) a source video stream corresponding to said requested video stream and (ii) splicing information associated with said source video stream;
determining video stream properties for said source video stream; determining splicing properties for said splicing information, said splicing
properties including identification of (i) out-splice points identified in said source video stream, and (ii) in-splice points identified in said source video stream;
packaging said source video stream, said source video stream properties, said splicing information, and said splicing properties for output to an edge server;
receiving at said edge server a second source video clip from a digital access generator server;
integrating said commercial video clip into said source video stream using at least one of said source video stream properties, said associated splicing information, and said splicing properties to produce a digital video stream; and
delivering said digital video stream from said edge server to video player software embedded in the IP-connected device;
wherein the digital video stream plays continuously, without discontinuity or explicit digital program insertion support from said video player software in the IP-connected device.

2. The method of claim 1 wherein said step of delivering said digital video comprises the step of accessing an internet protocol network.

3. The method of claim 1, further comprising the step of normalizing said splicing information prior to said step of providing to said ingest server.

4. The method of claim 1, further comprising the step of, prior to said step of providing to said ingest server, modifying said source video stream by at least one of transcoding and transrating said source video stream.

5. The method of claim 1 further comprising the step of conveying said properties of said source video stream and said splicing information to said edge server from said ingest server via one or more of: (i) Society of Cable Telecommunications Engineers standards 30/35/104, (ii) dual tone, multi frequency (DTMF) cue tones. (iii) closure of an electronic relay or contact, (iv) manual switching, (v) XML feed, (vi) third-party software output, (vii) a hypertext transfer protocol flag, and (viii) a simple network management protocol trap.

6. The method of claim 5 wherein said step of conveying comprises the step of transporting said properties of said source video stream and said splicing information via an Internet Protocol network.

7. The method of claim 1, wherein said ingest server comprises a Hypertext Transfer Protocol (HTTP) daemon, said HTTP daemon for providing an HTTP live stream (HLS) video stream to said edge server.

8. The method of claim 1, further comprising:
sending a request for a second source video stream, said request transmitted to at least one of an application server, a video platform, an HTTP video player, and a video server;
receiving said second source video stream at either said ingest server or said edge server;
determining if said second video stream had previously been received by either said ingest server or said edge server; and
creating one of an XML request or an HTTP GET request for said second source video stream by including a location for said second source video stream within an Uniform Resource Locator (URL).

9. The method of claim 8 wherein said step of sending a request for a second source video stream comprises the steps of:
preparing one of an HTTP GET OR PUT request;
sending said one of said HTTP GET OR PUT request to at least one of an application server, a web service, or a content management system (CMS); and
receiving at least one of a VAST XML response or an HTTP GET OR PUT response from one or more of said application server, said video platform, said HTTP video player, and said video server.

10. The method of claim 8 wherein said step of determining if said second source video stream had previously been received comprises the steps of:
analyzing data within said second source video stream to determine validity;
if said second source video stream has validity, determining to use said second source video stream;
if said second source video stream is not valid, continue sending said digital video stream to said video player software.

11. The method of claim 8 wherein said step of determining if said second source video stream had previously been received comprises the steps of:
determining properties of said second source video stream;
modifying said second source video stream by performing at least one of a transcoding and a transrating on said second source video stream so as to precisely match properties of said second source video stream with said source video stream;
determining a precise run time for said modified second source video stream; and
storing said modified second source video stream on one or more IP-connected storage devices.

12. The method of claim 8, further comprising the steps of:
determining the total time period in which said second source video stream may be spliced into the said video source stream based on said normalized splicing information;
determining the total run time period of said second source video stream that may be spliced into the said video source stream based on said video source stream properties;
determining a quantity of said second source video streams that can be spliced into said first source video stream without exceeding an available time period, said available time period determined from said normalized splicing information;
splicing said second source video stream into said source video stream;
outputting said second source video stream and said modified stream properties from said edge server, transported via an Internet Protocol network as a second digital video stream to at least one said video player software embedded in an IP-connected device, upon request by a user of said IP-connected device;
wherein said second digital video stream is delivered without requiring discontinuity or explicit DPI support from either said respective video player software or said HTTP video player.

13. The method of claim 8, wherein Hypertext Transfer Protocol (HTTP) daemon (web server) servers are used for HTTP live stream (HLS) video streams at said edge server and at said ingest server.
